(19) United States
(12) Patent Application Publication
(10) Pub. No.: US 2006/0007243 A1
(43) Pub. Date: Jan. 12, 2006

(54) Method for incorporating personalized content into a video format

(76) Inventor: Kevin Jacob Miller, Chicago, IL (US)

Correspondence Address: JENKENS & GILCHRIST, P.C., 225 WEST WASHINGTON, SUITE 2600, CHICAGO, IL, 60606, US

(21) Appl. No.: 10/990,829

(22) Filed: Nov. 17, 2004

Related U.S. Application Data
(60) Provisional application No. 60/520,860, filed on Nov. 18, 2003.

(51) Int. Cl. G09G 5/00

(52) U.S. Cl. 345/619

(57) ABSTRACT

A method of making a customized video including customized content. The method includes providing a plurality of standardized frames and adding at least one customized frame between at least two of the plurality of standardized frames. The at least one customized frame includes customized content and, at most, a standardized border.

### FIELD OF THE INVENTION

The invention relates to using videos to teach children and infants, and specifically to the use of personal content in a video format to educate children and/or infants.

### BACKGROUND OF THE INVENTION

Wide ranges of instructional and educational methods have been created over the years in an attempt to convey knowledge from an information source, such as a teacher, to a student or group of students. It is believed that people most effectively digest information when provided with visual images of the subject matter.

Throughout time, much of the existing teaching methods have relied on textbooks and reading to educate using visual images. Textbooks are limited by being two-dimensional images and requiring that the student be proficient at reading the language.

To combat this, educational videos have been created in the past with hopes of overcoming traditional limitations. These videos are generally considered to be an important part of the growth and development of infants and toddlers.

These videos, however, are lacking, because the videos are mass produced and tend to only reinforce images chosen by the creator of the video, and not the images that may have been chosen by the parent, caregiver, or teacher. These educational video aids lack the ability to be personalized to include specific content that directly applies to the student.

These videos also lack the ability to reinforce the recognition of family members. Family recognition is a developmental milestone and is also important for family bonding.

Therefore, there is a need to provide an effective and efficient method for teaching personalized information via images that directly apply to, and were chosen specifically for, the individual child or children.

Furthermore, there is a need to provide children with personalized videos that reinforce familial recognition while also stimulating the child's educational development.

### SUMMARY OF THE INVENTION

The instant invention is directed to an interactive method of conveying personalized information from a specific source, such as a parent or caregiver, to a student, such as a child or grandchild. The method employs using specific, personalized content within a general video to convey information. The personalized content can be randomly chosen, or repeated in response to the requests, or needs of, the student.

The above summary of the present invention is not intended to represent each embodiment, or every aspect, of the present invention. This is the purpose of the figures and the detailed description which follow.

### BRIEF DESCRIPTION OF THE DRAWINGS

The foregoing and other advantages of the invention will become apparent upon reading the following detailed description and upon reference to the drawings.

FIG. 1 is a series of illustrations of sequentially displayed video images according to one embodiment of the present invention.

FIG. 2 is a flowchart describing one method of performing the present invention.

FIG. 3 is a flowchart describing another embodiment of the present invention.

FIG. 4 is a flowchart describing yet another embodiment of the present invention.

FIG. 5 is another flowchart describing another embodiment of the present invention.

FIG. 6 is a series of illustrations of sequentially displayed video images according to one embodiment of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF ILLUSTRATIVE EMBODIMENTS

The present invention is directed to a video including standardized content and customized content. As used herein, the term video can refer to a VHS tape, a DVD, an MPEG, or other known format for viewing visual images.

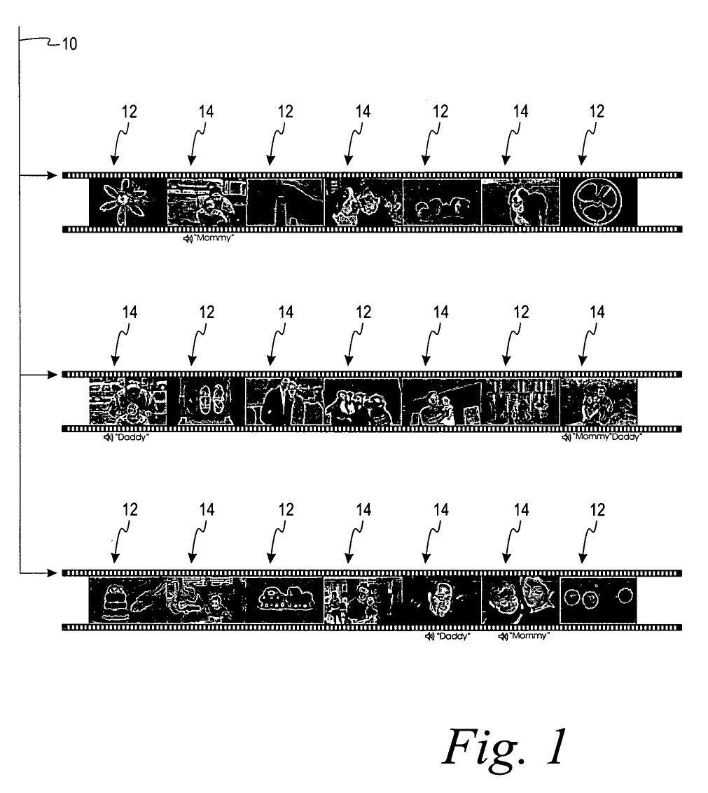

Turning now to FIG. 1, one embodiment of the present invention will be described. A reel strip 10 of the video is shown. The reel strip 10 includes standardized content 12 and customized content 14. The standardized content 12 are included in numerous videos in a standard format, and do not change per video. In contrast, the customized content 14 is content chosen individually for the recipient of the video.

As shown in FIG. 1, the customized content 14 is interspersed between the standardized content 12, in order to create a personalized video for the recipient. In the illustrated embodiment, the customized content 14 are digital photographs that are taken with a digital camera or scanned into a digital format and stored on a computer or other storage medium. In this embodiment, the customized content is generally photographs of relatives, pets, and/or friends of the recipient. The photographs may be cropped or reformatted to fit into the frame. Additionally, the photographs may be placed onto a standard background or with a standard border.

Instead of still photographs, the customized content 14 may include portions of a personalized video (digital or analog) submitted by the parent and/or caregiver. In another embodiment, the customized content 14 may include digital audio files. One example of this may be a personalized message for the child, such as the grandparent saying “Grandma Loves Bobby.”

Also, in some embodiments of the present invention, a text title labeling the personalized image may also be presented on the screen along with the customized content 14. In other embodiments, an audio label identifying the person, pet, and/or object in the customized content 14 may be stated to reinforce the name of those in the personalized video. This audio label may be a voice that is recorded by someone familiar with the child (e.g., mother or father), the child itself, or may be done by the video production crew. In yet another embodiment, the video reel 10 may be accompanied by music or other audio stimulation.

Also, in another embodiment, the invention may include adding personalized educational content to a more generic scholastic content. Examples of this embodiment may include an application to historical learning where local/specific historical content is added to a broader historical learning. Specifically, a history teacher may add content into a generic film about the Civil War that includes events that occurred in that town during the relevant time period. Another example would be if a coach/teacher wanted to provide specific coaching/teaching methods to a more generic teaching source. In this form of embodiment the educator/teacher would provide specific information to be added to the more generic subject to create a unique educational video. Specifically, the coach may include content showing the competitor doing a particular move in a section of the generalized video on how to counteract such a move.

In another embodiment of the present invention, the customized content 14 may be a frame customized to teach a particular skill or specific knowledge to the recipient. For example, as shown in FIG. 1b, a reel 20 is shown with standardized content 22 and customized content 24. The customized content 24 are images spelling out a particular word, such as the recipient's name (in this case, Jake). In such an instance, instead of being used to teach recognition of a family member, the personalized video is being used to teach how to spell a specific word chosen by the customer.

In another embodiment, the customized content 24 may include pictures of objects that the recipient is to learn. For example, the person purchasing the video, may choose 10-20 different objects from a list. Images of these objects (and in some cases, audio descriptions of the objects) would then be interspersed between the standardized content 22 of the video.

In some of the above embodiments, the customized content can include images of words and audio of words in foreign languages, such as Spanish, Japanese, Chinese, German, French, Hebrew, etc. . . . . In those embodiments, the customized content would also aid in the learning of a foreign language. The purchaser of the video would be able to choose specific words either from a list or to provide words unique chosen by the purchaser to be taught on the video.

The above embodiments can also be used to teach children with learning disabilities. The customized content can be chosen to be focused on an area in which the child has difficulty. For example, if a child has a speech impediment involving difficulty in pronouncing the “r” sound, the customized content can include lots of images and audio of words that begin with the letter “r” and encourage the child to repeat it. This is especially useful because it allows the caregiver or person showing the video to customize the video to the child's specific needs, which aids in the learning process.

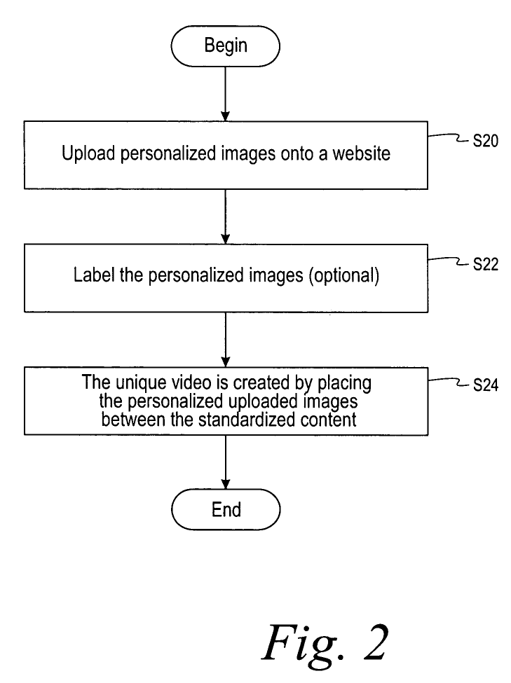

Turning now to FIG. 2, a flow chart depicting one method of personalizing the videos is shown. In this embodiment, the customized content is assumed to be a personalized image. At step S20, a customer uploads (or e-mails) personalized images onto a secure website via the internet. Optionally, at step S22, the customer may label the personalized images. This label may be in the form of text and/or audio labels submitted via the Internet with digital audio. Optionally, the audio can be spoken and recorded via phone and/or sent via mail in the form of an audio tape. In another embodiment, the production crew may record audio labels to be added to each personalized image.

At step S24, placing the personal uploaded content between standard-content images creates the unique video by performing the following. The images are resized to fit in the frame and renamed (if needed). An existing program such as “Final Cut Pro” by Apple Computer, Inc. is opened, and contains the standardized reel sequences. Each of the standardized sequences is then edited to include the saved images and or other personalized information (child's name, date of birth, etc. . . . ) from the local computer. The customized images are edited as needed. The computer program then saves the final product as an mpeg or other video file.

In some embodiments, a VHS tape can be recorded. When the final video is prepared, a VHS recorder is connected to the computer. The VHS recorder can then record the video from the computer.

In other embodiments, DVD creation software, such as iDVD or Roxio Toast can be used. The video file is then imported into the software program and the software “burns” the DVD.

The final product is then uniquely labeled and put into a unique case bearing the child's name and possibly other information.

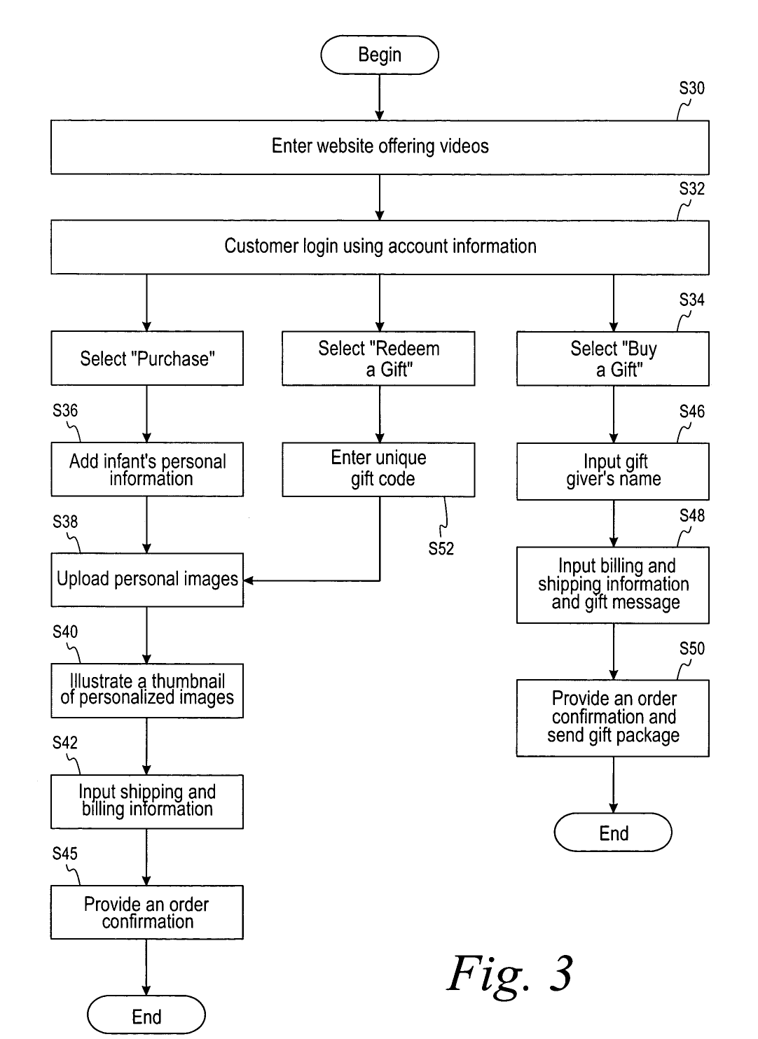

In FIG. 3, a more detailed process for uploading and ordering the video is illustrated. At step S30, a customer goes to a website offering the sales of personalized videos. Next, the customer logs in at step S32 using existing account information or using new account information. At step S34, the customer chooses a purchase option, either to buy a video for herself, buy a video as a gift or redeem a coupon for a video gift.

If the person chooses to buy a video, the process proceeds to step S36 and the infant's personalized information (name, date of birth, etc. . . . ) are input into the website. Also, the purchaser inputs how many pictures, up to a limit, are being uploaded into the video. The purchaser is also asked if she would like to buy additional copies of the video.

Then, at step S38, the customer uploads the personalized content (such as pictures) of her choice by finding the content on their personal computer. In some embodiments, the customer may wish to label his or her pictures with text. After all the pictures have been uploaded, a thumbnail of the personalized image is shown at step S40, along with the label selected or provided by the customer. At step S42, the client is asked to input the billing and shipping information. The client is then given an order confirmation number (S45), and the video is prepared for shipping to the customer.

If the customer chooses to purchase the video as a gift at step 34, the process then proceeds to step S46 and the customer is asked to input whom the gift is for and whom the gift is from. Then, the process proceeds to step S48, requesting billing and shipping information. The customer is also given an option to include a gift message to the recipient of the gift. At step S50, an order confirmation is given, and a gift code is sent to the recipient of the gift.

Once someone receives the gift code, they can go to the website to redeem it. At step S34, the gift recipient chooses to redeem a gift. At step S52, the recipient enters his personal gift code. The process then reverts back to step S36 and begins the process of personalizing the video, with the exception that the process does not require the input of billing information at step S42, only shipping information.

In addition, the actions of FIG. 3 could be handled over the phone with the personalized images sent via mail or e-mail.

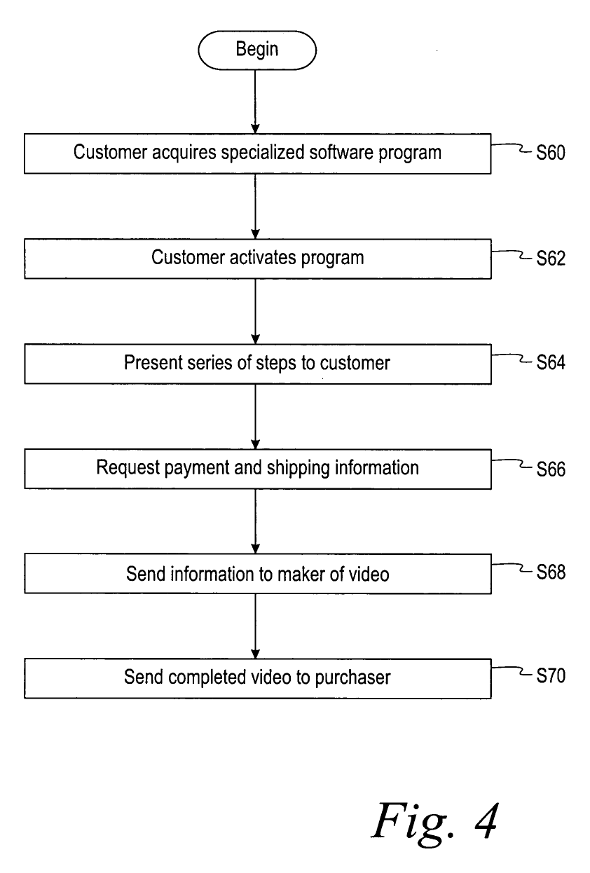

Turning now to FIG. 4, another embodiment of the present invention will be described. In this embodiment, the consumer receives a software program (either by purchasing it at a store or over the internet or being given the software) (step S60). The software could be in the form of a disk, a CD-ROM or other digital storage device or downloaded onto the user's computer from the internet. At step S62, the program is activated on their personal computer. The software then instructs the user, at step S64, to input personalized information including, but not limited to, the recipient's name, date of birth, place of birth. At this step, the user is also instructed to provide the customized content, such as digital images, video, and/or audio. A description of the content may also be included.

Next, at step S66, payment and/or shipping information is then provided by the user. After the user concludes the software program (which may involve clicking a “finish” or an “end” button), the information is then sent to the production company for production of the video (step S68) and the user is then mailed the personalized video (step S70).

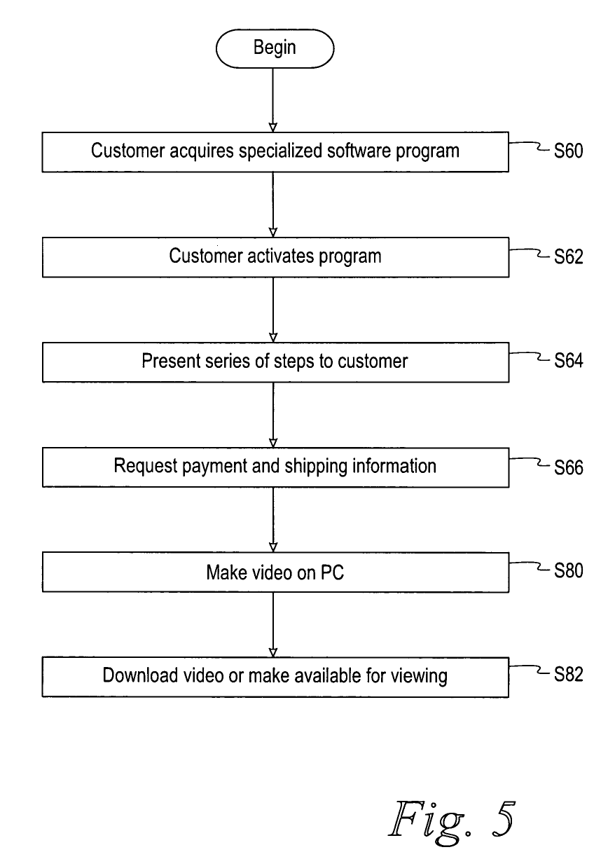

Turning now to FIG. 5, another embodiment of the present invention is described. In this embodiment, steps S60-66 are the same as described above, with the exception that the user does not need to provide shipping information. Then, at step S80, the personalized video is created by the software program. This may be accomplished by utilizing other software programs on the user's computer such as Final Cut Pro or Adobe Premiere. Alternatively, the software program purchased by the user may include all the editing software. At step S82, the final video is then available on the user's computer for viewing on the computer or downloading onto a DVD or other video format.

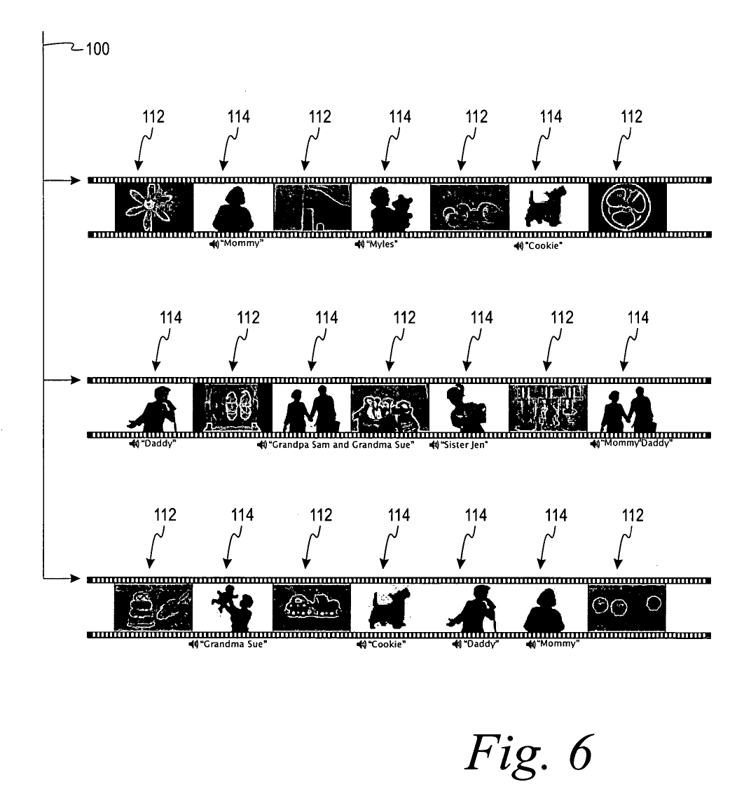

Turning now to FIG. 6, another embodiment of the present invention will be described. In this embodiment, a reel 100 is shown illustrating standardized content 112 and shadowed content 114. However, in this embodiment, the video is a demo video for showing user's how the personalized video would look. In the place of the customized content 14 of FIG. 1, shadows or silhouettes of commonly used images are placed. The shadowed content may also be cartoon images. This enables a user to see what the product will look like prior to purchasing the video or supplying their customized content. The demo may also include ordering information and instructions on how to choose content.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

What is claimed is:

1. A method of adding customized content in a prefabricated video to reinforce learning, the method comprising:
providing standardized content;
adding customized content to the standardized content to create a customized video;
presenting the customized video containing the customized content to a viewer to promote the learning of the customized content.

2. The method of claim 1 wherein adding customized content includes adding at least one of a personalized photograph, a personalized video, and a personalized audio file.

3. The method of claim 1 wherein adding customized content includes acquiring digital images via the internet and inserting the digital images into the video.

4. The method of claim 1 wherein adding customized content includes adding the customized content multiple times into the video.

5. The method of claim 1 wherein adding customized content further includes adding a text title identifying the customized content.

6. The method of claim 1 wherein adding customized content further includes adding an audio label identifying the customized content.

7. The method of claim 1 wherein presenting the customized video includes presenting the customized video to a child with learning disabilities such that the customized video promotes learning by the child.

8. The method of claim 1, further comprising adding music to the video, the music playing over the display of the standardized content and the customized content.

9. A customized video including customized content comprising:
a plurality of frames containing standardized content; and
at least one customized frame including customized content and, at most, a standardized border, wherein the at least one customized frame is between at least two of the plurality of frames containing standardized content.

10. The customized video of claim 9 wherein the at least one customized frame does not include a standardized border.

11. The customized video of claim 9 wherein the at least one customized frame comprises a personalized image.

12. The customized video of claim 11 wherein the personalized image is one of a photograph and video.

13. The customized video of claim 9 wherein the at least one customized frame comprises an audio file.

14. The customized video of claim 13 wherein the audio file includes words in a language other than English.

15. The customized video of claim 13 wherein the audio file includes words identifying an image on the customized frame.

16. The customized video of claim 9 wherein the at least one customized frame comprises an image relating to a specific subject.

17. The customized video of claim 16, wherein the specific subject is a word, and the at least one customized frame includes an image of the word.

18. The customized video of claim 9 wherein the customized content is originated by a consumer.

19. The customized video of claim 9 wherein the customized content is originated by a maker of the customized video.

20. The customized video of claim 9 wherein the customized frame includes a test title.

21. A method of making a customized video including customized content comprising:
providing a plurality of standardized frames; and
adding at least one customized frame between at least two of the plurality of standardized frames, the at least one customized frame including customized content and, at most, a standardized border.

22. The method of claim 21 wherein the step of adding customized content includes adding at least one of a personalized photograph, a personalized video, and a personalized audio file.

23. The method of claim 21 wherein the step of adding customized content includes acquiring digital images via the internet and inserting the digital images into the video.

24. The method of claim 21 wherein the step of adding customized content includes acquiring images via the mail, converting the images to digital images, and inserting the digital images into the video.

25. The method of claim 21 wherein the step of adding customized content further includes adding a text title identifying the customized content.

26. The method of claim 21 wherein the step of adding customized content further includes adding an audio label identifying the customized content.

27. The method of claim 26 wherein the audio label includes words in a language other than English.

28. The method of claim 21 further comprising adding music to the prefabricated video, the music playing over the display of the standardized content and the customized content.

29. The method of claim 21 further comprising periodically updating the video by adding at least one new customized frame.

30. The method of claim 21 wherein the at least one customized frame is created by a person making the video.

31. The method of claim 30 wherein the at least one customized frame is used to promote learning of a specific subject.

32. The method of claim 21 further comprising providing a consumer with software that requests the customized content from the consumer.

33. The method of claim 32 further comprising transmitting the customized content to a maker of the video.

34. The method of claim 33 further comprising the maker of the video sending the customized video to the consumer.

35. The method of claim 32 wherein the adding at least one customized frame is performed by the software.

36. A system for providing a customized video including customized content comprising:
a customized video including a plurality of frames containing standardized content, and at least one customized frame including customized content and, at most, a standardized border, wherein the at least one customized frame is interspersed between the plurality of frames containing standardized content; and
a standardized video including the plurality of frames containing standardized content; and at least one mock frame interspersed between the plurality of frames containing standardized content, the at least one mock frame designed to illustrate to a viewer the placement of the customized content.

37. The system of claim 36 wherein the standardized video further includes a tutorial section for teaching the viewer how to choose images for the at least one customized frame.

38. The system of claim 36 further comprising an instructional booklet for teaching the viewer how to choose images for the at least one customized frame.

39. The system of claim 36 wherein the at least one mock frame includes silhouettes of people.

40. The system of claim 36 wherein the at least one mock frame includes cartoon characters.
